(19) United States
(12) Patent Application Publication
(10) Pub. No.: US 2025/0320932 A1
(43) Pub. Date: Oct. 16, 2025

(54) INDEXABLE PLUMBING SYSTEM

(71) Applicant: GEM Products, LLC, Jacksonville, FL (US)

(72) Inventor: Jason Sarnowski, St. Augustine, FL (US)

(73) Assignee: GEM Products, LLC, Jacksonville, FL (US)

(21) Appl. No.: 19/174,026

(22) Filed: Apr. 9, 2025

Related U.S. Application Data
(60) Provisional application No. 63/632,202, filed on Apr. 10, 2024.

(51) Int. Cl. F16K 31/60; F16K 15/04

(52) U.S. Cl. CPC F16K 31/60; F16K 15/04

(57) ABSTRACT

The present invention broadly comprises an indexable valve which is slidable inserted into an alignment collar, such that the indexable valve and the alignment collar can index the location of the valve body relative to an installation surface. This allows an actuation device for the valve control to be placed in a preferred or predetermined location prior to installation. This may allow for the actuation device to be accessed even when the indexable valve is installed with limited clearance, such as next to an adjacent indexable plumbing system, within a pump box, or in other limited clearance situations.

### CROSS-REFERENCE TO RELATED APPLICATIONS

This application claims priority to U.S. Provisional Patent Application No. 63/632,202, filed Apr. 10, 2024, the contents of which are incorporated herein by reference in their entirety.

### TECHNICAL FIELD OF THE INVENTION

The present invention relates generally to valves. More particularly, the present invention relates to an indexable valve.

### BACKGROUND OF THE INVENTION

Plumbing components, such as valves, are commonly used to control the flow of a fluid, such as a liquid or a gas, within plumbing systems. In some embodiments, the plumbing system may be used in marine applications to control the flow of water from a pump box to a live well or as a through hull system including a seacock.

Plumbing components may use an actuation device, such as a lever or knob, to open and close the valve as needed. Positioning of the valves in relation to other plumbing components, surrounding housings, additional valves, and other nearby features is crucial to useability and functionality of the valve, as well as other components, such as seals. Traditional valves must be coupled to plumbing components, such as a pipe, with a threaded connection, which requires the valve to be threadably rotated relative to the mating plumbing component during installation of the valve to the plumbing components to ensure securement and sealing. The nature of threads makes predicting the final position of an adequately engaged threaded connection difficult, which may result in the actuation device of the valve, such as a handle, being difficult to access because it is blocked by surrounding components. Additionally, operation of the actuation device during use of the plumbing system can often transfer rotational force on the threaded connection, which could lead to the valve becoming loosened from a mating component or damaging internal sealing components, resulting in leaks and/or loss of pressure.

### SUMMARY OF THE INVENTION

The present invention broadly comprises an indexable valve which allows a user to index a valve body to an installation surface prior to installing the valve to set and maintain the valve body in a desired final location prior to complete installation. The indexable valve includes a valve assembly. In an embodiment, the valve assembly includes a valve housing having a first opening with a set of internal threads and a second opening having another set of internal threads. In further embodiments, the valve housing may include additional openings, such as a three or four port valve. A valve closure mechanism, such as, for example, a ball valve or gate valve, is disposed in the valve housing and is coupled to an actuation device, such as a handle, accessible outside the valve housing, which may be manipulated by a user to control flow of fluid within the valve assembly. First and second alignment protrusions are formed on an outer surface of the valve housing. The first alignment protrusion may include first and second alignment surfaces.

In an embodiment, an alignment collar includes a collar ring and a flange. The collar ring includes first and second receiving features. The first receiving features includes first and second receiving edges. The collar ring is adapted to surround the first opening of the valve housing, such that the first alignment protrusion of the valve housing is matingly received by the first receiving feature of the collar ring, the first and second alignment surfaces are matingly received by the first and second alignment edges, and the second alignment protrusion of the valve housing is matingly received by the second receiving feature of the collar ring, thus preventing rotation of the valve assembly. The flange includes circumferentially disposed bosses arranged in a circular pattern around the flange. A first portion of the bosses have a first height and a second portion of the bosses have a second height which is less than the first height.

A gasket includes through holes, a central opening, and an inner seal. The through holes respectively engage the bosses of the flange.

A fitting with external threads includes a first end that is adapted to threadably engage the internal threads of the first opening of the valve housing, and a second end opposite the first end. In embodiments, the second end is adapted to threadably engage a coupling nut. The fitting may pass through the central opening of the gasket and the flange of the alignment collar, such that the set of external threads threadably engages the internal threads of the first opening of the valve housing. In various embodiments, additional versions of the fitting may be used.

A user may index the valve body and the alignment collar relative to the installation surface prior to installation of the indexable valve. By indexing the valve body to the installation surface, a user may set the location of the actuation device for the valve so that the actuation device may be free from interference from surrounding structures when installed. Moreover, with the indexing system of the present invention, rotation of the valve caused by rotation of the actuation device is better controlled and minimized, thus decreasing the chance of the valve threaded connections becoming loose over time.

In an embodiment, the present invention broadly comprises an indexable valve that includes a valve assembly including: a valve housing forming a fluid channel therein, the fluid channel having opposing first and second openings, the first opening including a set of internal threads, a valve control disposed in the fluid channel, an actuation device adapted to actuate the valve control, and a first alignment protrusion formed on an outer surface of the valve housing proximate to the first opening. The indexable valve includes an alignment collar including: a first receiving feature adapted to matingly receive the first alignment protrusion, and a flange including outwardly protruding bosses. The indexable valve includes a gasket including through holes. The indexable valve includes a fitting having a first end including a set of external threads and a second end, wherein the set of external threads is adapted to threadably engage the internal threads of the valve housing.

In another embodiment, the present invention broadly comprises an indexable valve including a valve assembly including a valve housing forming a fluid channel therein, the fluid channel having a first opening including a set of internal threads and a second opening opposite the first opening, a valve control disposed in the fluid channel, an actuation device adapted to actuate the valve control, and a first alignment protrusion formed on an outer surface of the valve housing proximate to the first opening. The indexable valve includes an alignment collar including: a first receiving feature adapted to matingly receive the first alignment protrusion, and a flange including outwardly protruding bosses. The indexable plumbing system includes a gasket including through holes. The indexable plumbing system includes a threaded insert having opposing first and second ends, wherein a set of external threads is formed on an outer surface between the first and second ends and the set of external threads is adapted to threadably engage the internal threads of the valve housing, and a coupling nut including a set of internal threads adapted to threadably engage the set of external threads of the threaded insert.

In another embodiment, the present invention broadly comprises an indexable valve including a valve assembly including a valve housing forming a fluid channel therein, the fluid channel having opposing first and second openings, the first opening including a set of internal threads, a ball valve disposed in the fluid channel, an actuation device handle adapted to actuate the ball valve, a first alignment protrusion formed on an outer surface of the valve housing proximate to the first opening, and a second alignment protrusion formed on the outer surface of the valve housing proximate to the first opening. The indexable valve includes an alignment collar including a first receiving feature adapted to matingly receive the first alignment protrusion, a second receiving feature formed on the alignment collar and adapted to matingly receive the second alignment protrusion, and a flange including outwardly protruding bosses wherein a first portion of the outwardly protruding bosses have a first height and a second portion of the outwardly protruding bosses have a second height which is shorter than the first height. The indexable valve includes a gasket including through holes. The indexable valve includes a fitting having a first end including a set of external threads and a second end, wherein the set of external threads is adapted to threadably engage the internal threads of the valve housing.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a first perspective, exploded view of an indexable valve, according to an embodiment of the present invention.

FIG. 2 is a second perspective, exploded view of the indexable valve of FIG. 1.

FIG. 3 is a side perspective view of an assembled indexable valve, according to an embodiment of the present invention.

FIG. 4 is a sectional side view along cutting line A-A in FIG. 3 of an assembled indexable valve, according to an embodiment of the present invention.

FIG. 5A is a perspective view of an exemplar fitting of an assembly indexable valve, according to an embodiment of the present invention.

FIG. 5B is a perspective view of another exemplar fitting of an assembly indexable valve, according to an embodiment of the present invention.

FIG. 6 a first perspective, exploded view of an indexable valve, according to another embodiment of the present invention.

FIG. 7 is a second perspective, exploded view of the indexable valve of FIG. 6.

FIG. 8 is a side perspective view of an assembled indexable valve, according to an embodiment of the present invention.

FIG. 9 is a sectional side view along cutting line B-B in FIG. 8 of an assembly indexable valve, according to an embodiment of the present invention.

### DETAILED DESCRIPTION OF THE EMBODIMENTS

While this invention is susceptible of embodiments in many different forms, there is shown in the drawings, and will herein be described in detail, embodiments of the invention, including a preferred embodiment, with the understanding that the present disclosure is to be considered as an exemplification of the principles of the invention and is not intended to limit the broad aspect of the invention to embodiments illustrated. As used herein, the term “present invention” is not intended to limit the scope of the claimed invention and is instead a term used to discuss exemplary embodiments of the invention for explanatory purposes only.

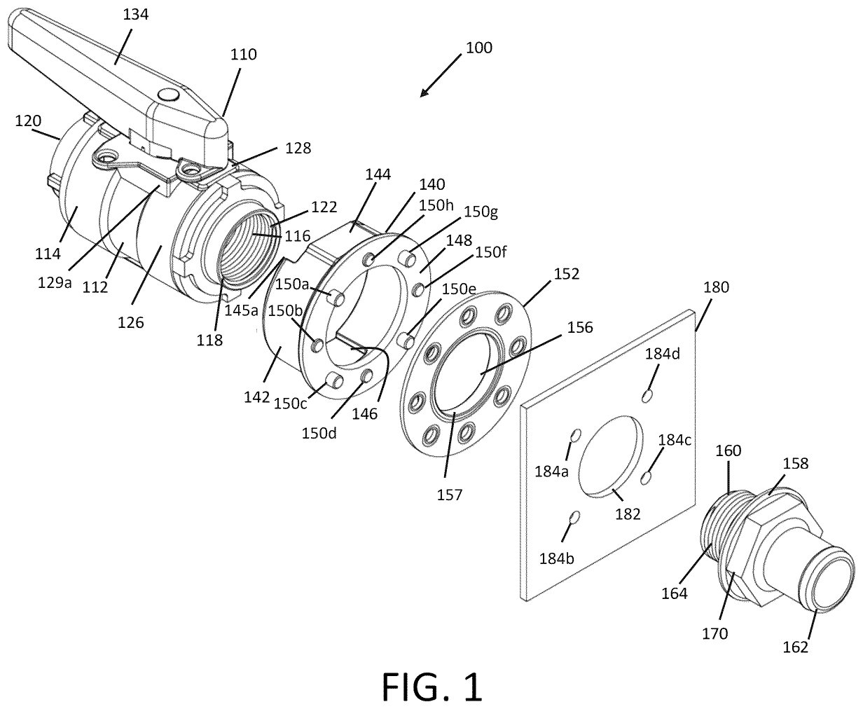

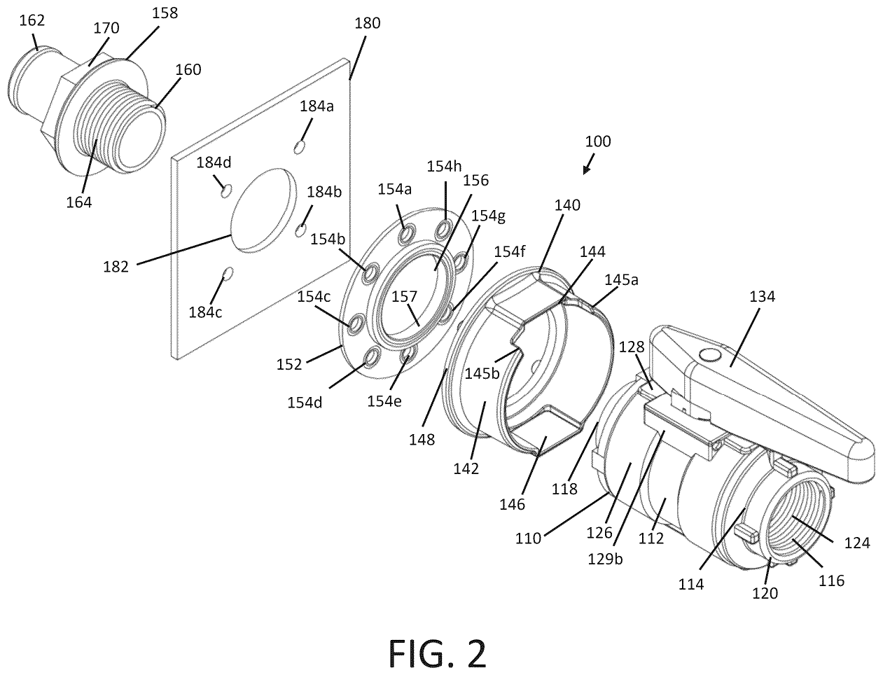

Referring to FIGS. 1 and 2, an embodiment of an indexable valve 100 and an installation surface 180 is shown. The indexable valve 100 includes a valve assembly 110. The valve assembly 110 includes a valve housing 112, which includes an outer wall 114 forming a fluid channel 116 therein. The fluid channel 116 includes opposing first and second openings 118, 120.

The first opening 118 includes first internal threads 122. The first internal threads 122 may be any suitable type of threads commonly used in plumbing components, including but not limited to National Taper Pipe (NPT), British Standard Pipe (BSP), or any other suitable type of threads. The second opening 120 may include second internal threads 124. The second internal threads 124 may threadably couple to additional plumbing components, such as pipes, fittings, hoses, nozzles, pumps, or any other suitable type of plumbing components, in a well-known manner. The first internal threads 122 and the second internal threads 124 may also be conditioned with thread compound or plumbers tape to minimize leaking, in a well-known manner. In further embodiments, the second opening 120 may include alternate couplings, such as, for example, a barbed end, adhesive, SharkBite®, compression, press-fit, solder, or other suitable alternate couplings.

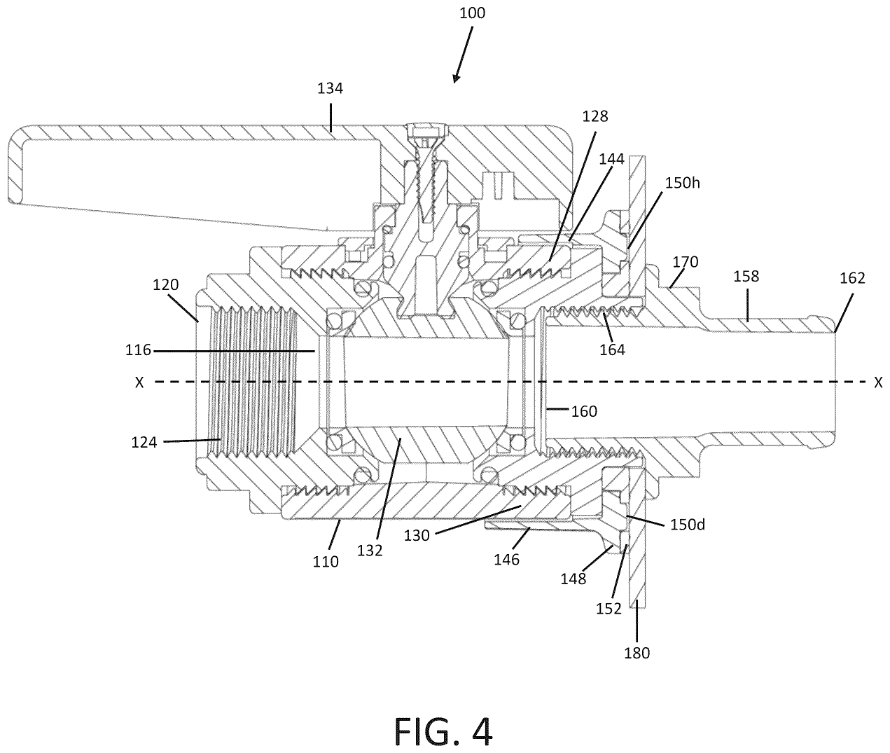

The outer wall 114 includes an outer surface 126 with diametrically opposing first and second alignment protrusions 128, 130 (second alignment projection 130 illustrated in FIG. 4). The first and second alignment protrusions 128, 130 may be keyed to respectively matingly fit within receiving features, as will be described below. The first alignment protrusion 128 includes opposing first and second alignment surfaces 129a, 129b. The first and second alignment protrusions 128, 130 may include one or more surfaces which are shaped and sized to be retained by the receiving features, as will also be described below.

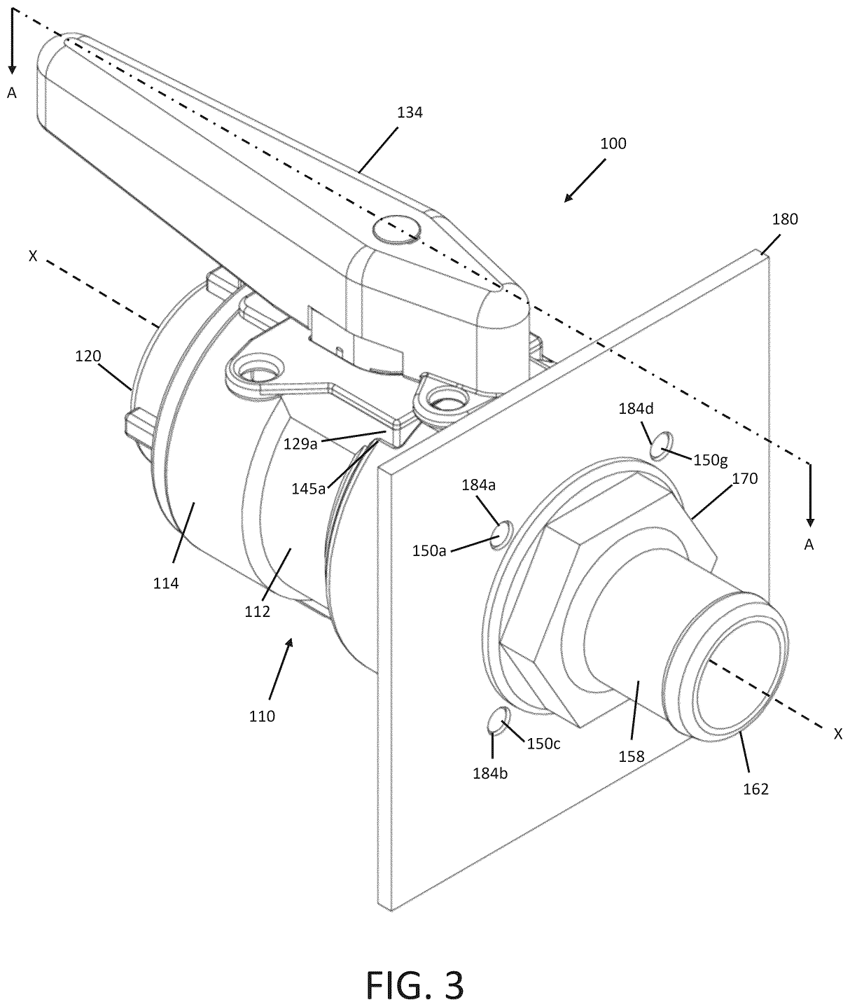

Referring also to FIGS. 3 and 4, a valve control 132 is disposed within the fluid channel 116, and is adapted to control fluid passing through fluid channel 116. For example, valve control 132 can be completely closed to prevent fluid from flowing through the fluid channel 116, can be completely opened to allow free flow of fluid in the fluid channel 116, or can be partially closed to control volume of fluid in the fluid channel 116. It will be appreciated that while the present invention is described as having a conventional ball valve for exemplar purposes, the present invention is not so limited. Any type of valve, such as, for example, ball valve, gate valve, check valve, and the like, can be used without departing from the scope and spirit of the present invention.

In an embodiment, an actuation device 134 is coupled to the valve control 132 and is accessible outside of the fluid channel 116. In an embodiment, the actuation device 134 is a handle, however, it will be appreciated that the actuation device 134 can be anything that can control the valve control 134, such as, for example, a handle, lever, knob, or automated device. The actuation device 134 may be used to rotate the valve control 132 in order to reduce or halt the flow of a fluid through the fluid channel 116.

In an embodiment, the valve 100 includes an alignment collar 140 having a collar ring 142. The collar ring 142 includes first and second receiving features 144, 146 formed therein. The first and second receiving features 144, 146 may be shaped and sized to respectively matingly receive the first and second alignment protrusions 128, 130, as will be described in more detail herein. The first receiving feature 144 includes first and second receiving edges 145a, 145b. The first and second receiving edges 145a, 145b are adapted to each respectively receive the first and second alignment surfaces 129a, 129b.

The alignment collar 140 includes a flange 148 that is substantially perpendicular to the collar ring 142. The flange 148 includes outwardly protruding bosses 150 circumferentially disposed around the flange 148. As illustrated, the flange 148 includes eight bosses 150a, 150b, 150c, 150d, 150e, 150f, 150g, and 150h, but it should be understood that, in embodiments, the flange 148 may include any suitable number of bosses 150. In an embodiment, bosses 150a, 150c, 150e, and 150g have a first height and bosses 150b, 150d, 150f, and 150h have a second height which is shorter than the first height.

In an embodiment, the indexable valve 100 includes a gasket 152 having through holes 154. As illustrated, the gasket 152 includes eight through holes 154a, 154b, 154c, 154d, 154e, 154f, 154g, and 154h, but it should be understood that, in embodiments, the gasket 152 may include any suitable number of through holes 154. The through holes 154 are adapted to respectively receive the bosses 150, such that the gasket 152 is aligned and retained on the alignment collar 140 when installed.

In an embodiment, the gasket 152 may include a central opening 156 to allow fluid to pass therethrough. The central opening 156 may include an inner seal 157 formed therearound, which may seal against the valve housing 112 during installation. The gasket 152 may be constructed of any suitable compliant material, including, for example, rubber, silicone, nitrile, or any other suitable material.

In an embodiment, the indexable valve 100 includes a fitting 158 having opposing first and second ends 160, 162. The first end 160 includes a set of external threads 164. The second end 162 may include coupling that is adapted to couple to additional plumbing components, such as pipes, fittings, hoses, nozzles, pumps, or any other suitable type of plumbing components. The coupling may include, for example, threads, a barbed end, adhesive, SharkBite®, compression, press-fit, solder, or other suitable alternate couplings. In an embodiment, the fitting 158 may include flats 170 that are adapted to allow the fitting 158 to removably couple to a tool, such as a socket or a pipe wrench, so that the fitting 158 may be threaded into the valve housing 112.

In an embodiment, the indexable valve 100 may be installed on an installation surface 180, such as a pump box, a boat hull, a cabinet wall, a sidewall, a bulkhead, or any other suitable installation surface. The installation surface 180 may include a central passage 182 formed therein that is shaped and sized to allow for the first end 160 of the fitting 158 to be passed therethrough. The installation surface 180 includes four installation holes 184a, 184b, 184c, and 184d. However, it should be understood that, in embodiments, the installation surface 180 may have any number of installation holes 184.

Referring also to FIGS. 3 and 4, the valve housing 112 may be inserted into the alignment collar 140 such that the first and second alignment protrusions 128, 130 are respectively matingly received by the first and second receiving portions 144, 146. By the first and second alignment protrusions 128, 130 being matingly received by the first and second receiving portions 144, 146, the valve housing 112 and the alignment collar 140 may be indexed relative to one another, such that a rotation of one of the valve housing 112 or the alignment collar 140 along axis X-X causes a rotation of the other component.

In an embodiment, each of the bosses 150 of the first height are respectively inserted through through holes 154 of the gasket 152, and the bosses 150 of the second height are respectively inserted through through holes 154 of the gasket 152 and installation holes 184.

The alignment collar 140 may be aligned at any angle relative to the installation surface 180 along axis X-X, such that the actuation device 134 may be placed in a desired location after installation is complete. That is, while boss 150a is illustrated as engaged with through hole 184a, the alignment collar 140 (and by extension the valve housing 112) may be rotated prior to installation such that any one of bosses 150c, 150e, or 150g may engage through hole 184a, based on the desired location of the actuation device 134 after installation. This allows an installer, for example, to dispose the actuation device 134 in a location that is more easily accessible or usable, depending on the installation environment of the indexable valve 100.

In an embodiment, the fitting 158 may be partially inserted through the central passage 182 of the installation surface 180, such that the set of external threads 164 threadably engages the set of internal threads 122 of the valve housing 112. With the fitting 158 and the valve housing 112 threadably engaging each other, the valve housing 112 and alignment collar 140 may compress the gasket 152 towards the installation surface 180 while the fitting 158 is drawn towards the installation surface 180 to create a fluid-tight connection.

The valve control 132 is disposed within the valve housing 112 and is coupled to the actuation device 134. By rotating the actuation device 134 relative to the valve housing 112, a user may control and/or stop the flow of liquid through the valve assembly 110.

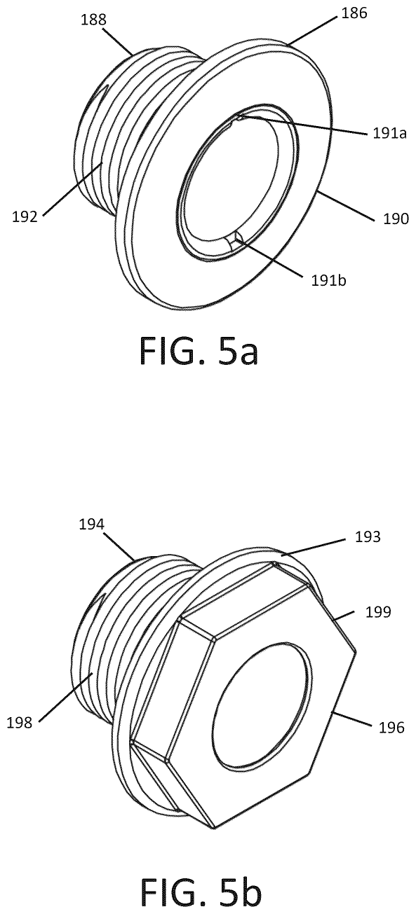

Referring to FIG. 5a, an embodiment of a first alternate fitting 186 is shown. The first alternate fitting 186 may be substituted for the fitting 158 in the indexable valve 100. The first alternate fitting 186 may be a through-hull fitting, such that the indexable plumbing valve 100 may be used as a seacock. The first alternate fitting 186 includes opposing first and second ends 188, 190. The first end 188 includes a set of external threads 192. The set of external threads 192 may be any suitable type of threads commonly used in plumbing components, including but not limited to National Taper Pipe (NPT), British Standard Pipe (BSP), or any other suitable type of threads.

The second end 190 may include a pair of opposing notches 191a and 191b placed diametrically opposed from one another. The notches 191a, 191b may allow the first alternate fitting 186 to be rotated with an installation tool, such as a spanner nut wrench. The second end 190 may be open, such that fluid may pass therethrough.

Referring to FIG. 5b, an embodiment of a second alternate fitting 193 is shown. The second alternate fitting 193 may be substituted for the fitting 158 in the indexable valve 100. The second alternate fitting 193 may be a through-hull fitting, such that the indexable plumbing valve 100 may be used as a seacock. The second alternative fitting 193 includes opposing first and second ends 194, 196. The first end 194 includes a set of external threads 198. The set of external threads 198 may be any suitable type of threads commonly used in plumbing components, including but not limited to National Taper Pipe (NPT), British Standard Pipe (BSP), or any other suitable type of threads.

The second end 196 may include a set of shoulders 199. The set of shoulders 199 may allow the second alternative fitting 193 to be rotated by a tool, such as a socket or a pipe wrench. The second end 196 may be open, such that fluid may pass therethrough.

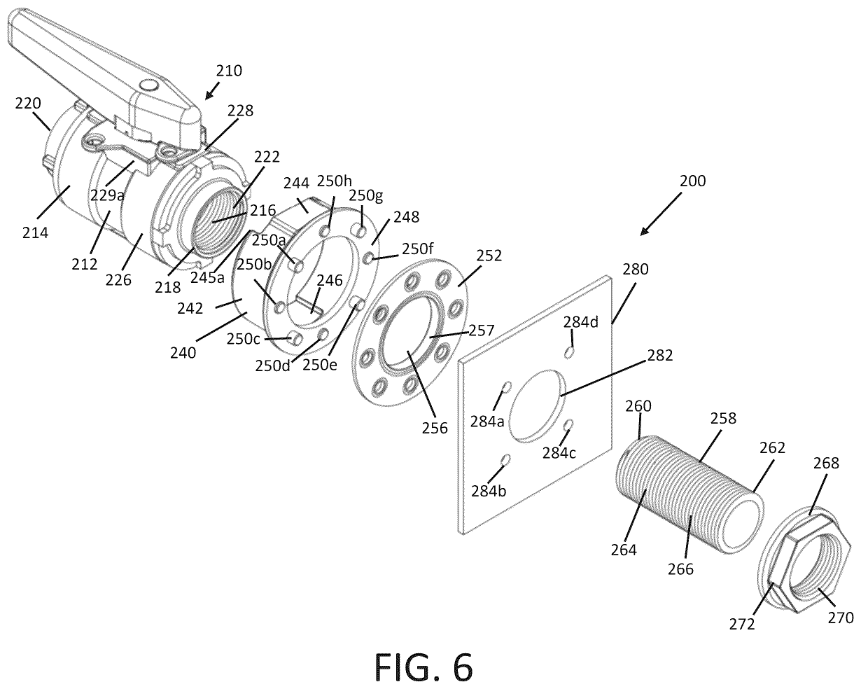

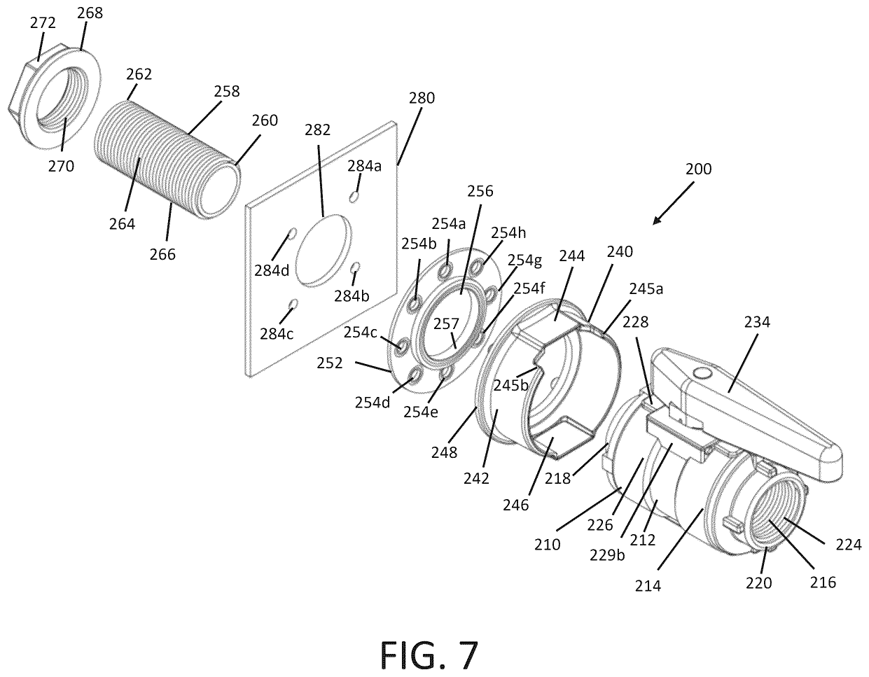

Referring to FIGS. 6 and 7, in another embodiment, an indexable valve 200 and an installation surface 280 is shown. The indexable valve 200 includes a valve assembly 210. The valve assembly 210 includes a valve housing 212, which includes an outer wall 214 forming a fluid channel 216 therein. The fluid channel 216 includes opposing first and second openings 218, 220.

The first opening 218 includes first internal threads 222. The first internal threads 222 may be any suitable type of threads commonly used in plumbing components, including but not limited to National Taper Pipe (NPT), British Standard Pipe (BSP), or any other suitable type of threads. The second opening 220 may include second internal threads 224. The second internal threads 224 may threadably couple to additional plumbing components, such as pipes, fittings, hoses, nozzles, pumps, or any other suitable type of plumbing components, in a well-known manner. The first internal threads 222 and the second internal threads 224 may also be conditioned with thread compound or plumbers tape to minimize leaking, in a well-known manner. In further embodiments, the second opening 220 may include alternate couplings, such as, for example, a barbed end, adhesive, SharkBite®, compression, press-fit, solder, or other suitable alternate couplings.

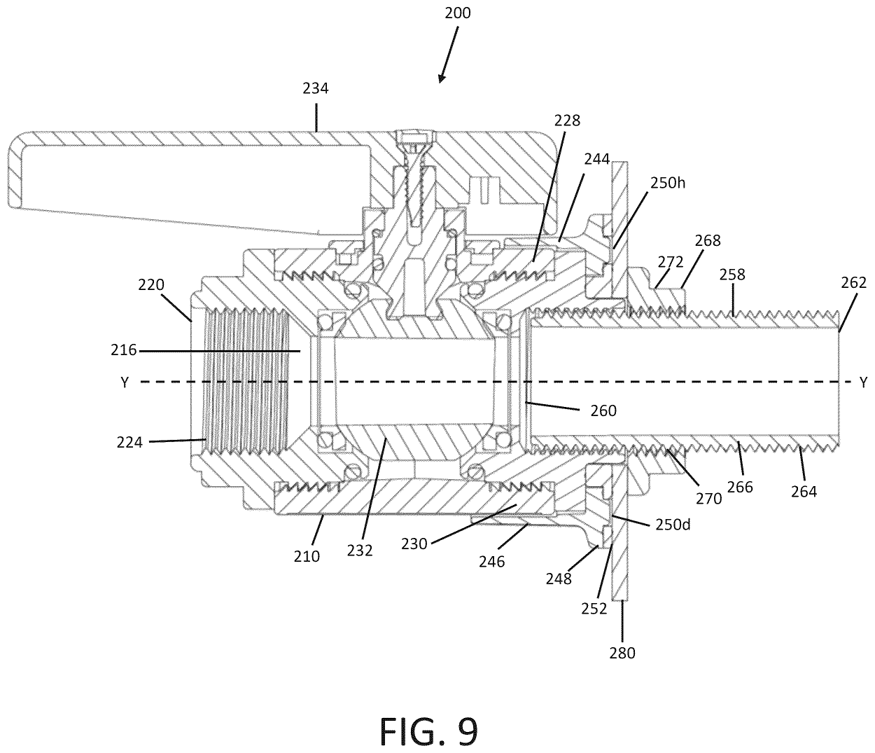

The outer wall 214 includes an outer surface 226 with diametrically opposing first and second alignment protrusions 228, 230 (second alignment protrusion 230 illustrated in FIG. 9). The first and second alignment protrusions 228, 230 may be keyed to respectively matingly fit within receiving features, as will be described below. The first alignment protrusion 228 includes opposing first and second alignment surfaces 229a, 229b. The first and second alignment protrusions 228, 230 may include one or more surfaces which are shaped and sized to be retained by the receiving features, as will also be described below.

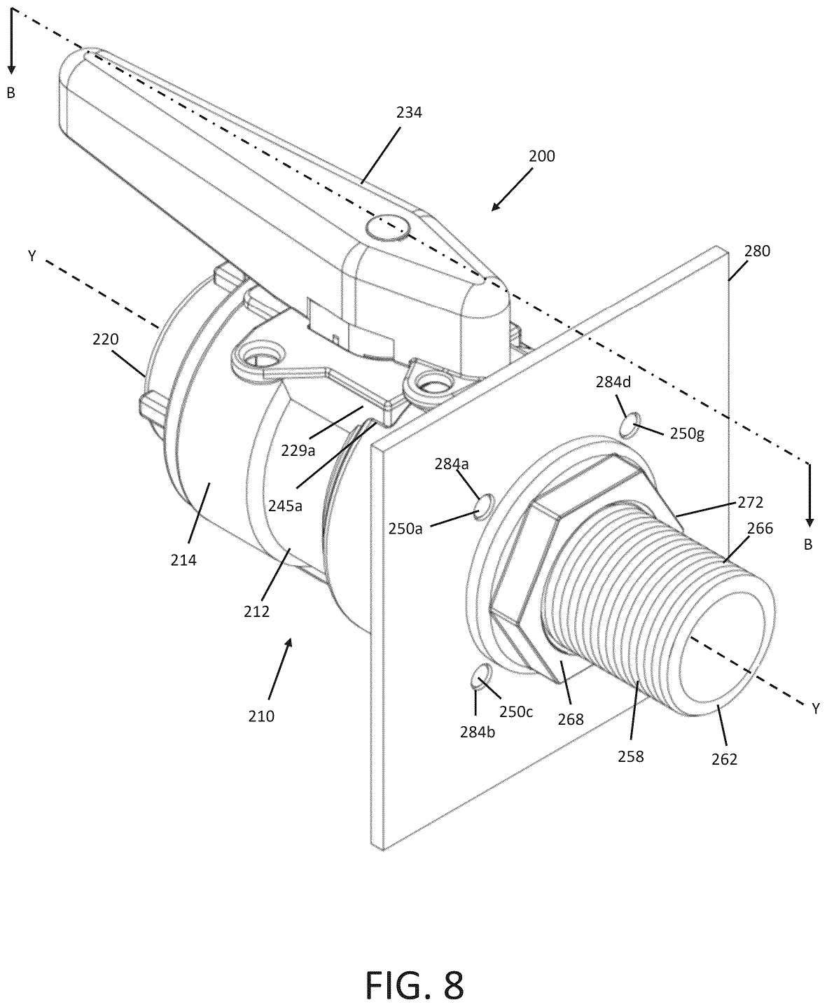

Referring also to FIGS. 8 and 9, a valve control 232 is disposed within the fluid channel 216, and is adapted to control fluid passing through fluid channel 216. For example, valve control 232 can be completely closed to prevent fluid from flowing through the fluid channel 216, can be completely opened to allow free flow of fluid in the fluid channel 216, or can be partially closed to control volume of fluid in the fluid channel 216. It will be appreciated that while the present invention is described as having a conventional ball valve for exemplar purposes, the present invention is not so limited. Any type of valve, such as, for example, ball valve, gate valve, check valve, and the like, can be used without departing from the scope and spirit of the present invention.

In an embodiment, an actuation device 234 is coupled to the valve control 232 and is accessible outside of the fluid channel 216. In an embodiment, the actuation device 234 is a handle, however, it will be appreciated that the actuation device 234 can be anything that can control valve control 234, such as, for example, a handle, lever, knob, or automated device. The actuation device 234 may be used to rotate the valve control 232 in order to reduce or halt the flow of a fluid through the fluid channel 216.

In an embodiment, the valve 200 includes an alignment collar 240 having a collar ring 242. The collar ring 242 includes first and second receiving features 244, 246 formed therein. The first and second receiving features 244, 246 may be shaped and sized to respectively matingly receive the first and second alignment protrusions 228, 230, as will be described in more detail herein. The first receiving feature 244 includes first and second receiving edges 245a, 245b. The first and second receiving edges 245a, 245b are adapted to each respectively receive the first and second alignment surfaces 229a, 229b.

The alignment collar 240 includes a flange 248 that is substantially perpendicular to the collar ring 242. The flange 248 includes outwardly protruding bosses 250 circumferentially disposed around the flange 248. As illustrated, the flange 248 includes eight bosses 250a, 250b, 250c, 250d, 250e, 250f, 250g, and 250h, but it should be understood that, in embodiments, the flange 248 may include any suitable number of bosses 250. In an embodiment, bosses 250a, 250c, 250e, and 250g have a first height and bosses 250b, 250d, 250f, and 250h have a second height which is shorter than the first height.

In an embodiment, the indexable valve 200 includes a gasket 252 having through holes 254. As illustrated, the gasket 252 includes eight through holes 254a, 254b, 254c, 254d, 254e, 254f, 254g, and 254h, but it should be understood that, in embodiments, the gasket 252 may include any suitable number of through holes 254. The through holes 254 are adapted to respectively receive the bosses 250, such that the gasket 252 is aligned and retained on the alignment collar 240 when installed.

In an embodiment, the gasket 252 may include a central opening 256 to allow fluid to pass therethrough. The central opening 256 may include an inner seal 257 formed therearound, which may seal against the valve housing 212 during installation. The gasket 252 may be constructed of any suitable compliant material, including, for example, rubber, silicone, nitrile, or any other suitable material.

In an embodiment, the indexable valve 200 includes a threaded insert 258 having opposing first end and second ends 260, 262. A set of external threads 264 is formed on an outer wall 266 between the first end 260 and the second end 262. The set of external threads 264 adjacent to the first end 260 engages the set of internal threads 222 of the valve housing 212. The set of external threads 264 adjacent to the second end 262 may couple to additional plumbing components, such as pipes, fittings, hoses, nozzles, pumps, or any other suitable type of plumbing components. In some embodiments, the threaded insert 258 may be formed integrally with the valve housing 212, such that the set of external threads 264 projects directly from the valve housing 212.

A coupling nut 268 may include a set of internal threads 270 and flats 272. The set of internal threads 270 are adapted to engage the set of external threads 264 adjacent to the second end 262 of the threaded insert 258. The flats 272 may be shaped and size to removably couple to a tool, such as a socket or a pipe wrench, so that the coupling nut 268 may be threaded onto the threaded insert 258.

In an embodiment, the indexable valve 200 may be installed on an installation surface 280, such as a pump box, a boat hull, a cabinet wall, a sidewall, a bulkhead, or any other suitable installation surface. The installation surface 280 may include a central passage 282 formed therein that is shaped and sized to allow for the first end 260 of the fitting 258 to be passed therethrough. The installation surface 280 includes four installation holes 284a, 284b, 284c, and 284d. However, it should be understood that, in embodiments, the installation surface 280 may have any number of installation holes 284.

Referring also to FIGS. 8 and 9, the valve housing 212 may be inserted into the alignment collar 240 such that the first and second alignment protrusions 228, 230 are respectively matingly received by the first and second receiving portions 244, 246. By the first and second alignment protrusions 228, 230 being matingly received by the first and second receiving portions 244, 246, the valve housing 212 and the alignment collar 240 may be indexed relative to one another, such that a rotation of one of the valve housing 212 or the alignment collar 240 along axis Y-Y causes a rotation of the other component.

In an embodiment, each of the bosses 250 of the first height are respectively inserted through through holes 254 of the gasket 252, and the bosses 250 of the second height are respectively inserted through through holes 254 of the gasket 252 and installation holes 284.

The alignment collar 240 may be aligned at any angle relative to the installation surface 280 along axis Y-Y, such that the actuation device 234 may be placed in a desired location after installation is complete. That is, while boss 250a is illustrated as engaged with through hole 284a, the alignment collar 240 (and by extension the valve housing 212) may be rotated prior to installation such that any one of bosses 250c, 250e, or 250g may engage through hole 284a, based on the desired location of the actuation device 234 after installation. This allows an installer, for example, to dispose the actuation device 234 in a location that is more easily accessible or usable, depending on the installation environment of the indexable valve 200.

In an embodiment, the fitting 258 may be partially inserted through the central passage 282 of the installation surface 280, such that the set of external threads 264 threadably engages the set of internal threads 222 of the valve housing 212. The set of internal threads 270 of the coupling nut 268 may engage the set of external threads 264 such that the coupling nut 268 abuts the installation surface 280. By the valve housing 212 and the coupling nut 268 threadably engaging the threaded insert 260, the valve housing 212 and alignment collar 240 may compress the gasket 252 towards the installation surface 280.

With the fitting 258, the valve housing 212, and the coupling nut 268 threadably engaging each other, the valve housing 212 and alignment collar 240 may compress the gasket 252 towards the installation surface 280 while the fitting 258 and coupling nut 268 are drawn towards the installation surface 280 to create a fluid-tight connection.

The valve control 232 is disposed within the valve housing 212 and is coupled to the actuation device 234. By rotating the actuation device 234 relative to the valve housing 212, a user may control and/or stop the flow of liquid through the valve assembly 210.

As used herein, the term “coupled” and its functional equivalents are not intended to necessarily be limited to direct, mechanical coupling of two or more components. Instead, the term “coupled” and its functional equivalents are intended to mean any direct or indirect mechanical or chemical connection between two or more objects, features, work pieces, and/or environmental matter. “Coupled” is also intended to mean, in some examples, one object being integral with another object.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of the inventors' contribution. The actual scope of the protection sought is intended to be defined in the following claims when viewed in their proper perspective based on the prior art.

What is claimed is:

1. An indexable valve comprising:
a valve assembly including a valve housing having a first alignment protrusion formed on an outer surface of the valve housing; and
an alignment collar including:
a first receiving feature adapted to matingly receive the first alignment protrusion; and
a flange including outwardly protruding bosses.

2. The indexable valve of claim 1, wherein the valve housing further includes a fluid channel formed therein, the fluid channel having opposing first and second openings.

3. The indexable valve of claim 2, wherein the first opening of the valve housing includes a set of internal threads.

4. The indexable valve of claim 3, further comprising:
a fitting having a first end including a set of external threads and a second end, wherein the set of external threads is adapted to threadably engage the internal threads of the valve housing.

5. The indexable valve of claim 4, wherein the second end of the fitting includes a through-hull fitting.

6. The indexable valve of claim 3, further comprising:
a threaded insert having opposing first and second ends, wherein a set of external threads is formed on an outer surface between the first and second ends and the set of external threads is adapted to threadably engage the internal threads of the valve housing; and
a coupling nut including a set of internal threads adapted to threadably engage the set of external threads of the threaded insert.

7. The indexable valve of claim 2, further comprising:
a set of external threads projecting outwardly from the first end of the valve housing; and
a coupling nut including a set of internal threads adapted to threadably engage the set of external threads.

8. The indexable valve of claim 1, further comprising:
a valve control disposed in the fluid channel; and
an actuation device adapted to actuate the valve control.

9. The indexable valve of claim 8, wherein the valve control is a ball valve.

10. The indexable valve of claim 1, further comprising a gasket including through holes.

11. The indexable valve of claim 10, wherein the gasket further comprises an inner seal.

12. The indexable valve of claim 1, further comprising:
second alignment protrusion formed on the outer surface of the valve housing proximate to the first opening; and
a second receiving feature formed on the alignment collar and adapted to matingly receive the second alignment protrusion.

13. The indexable valve of claim 1, wherein a first portion of the outwardly protruding bosses have a first height and a second portion of the outwardly protruding bosses have a second height which is shorter than the first height.

14. The indexable valve of claim 1, wherein the first receiving portion further comprises a plurality of receiving edges.

15. The indexable valve of claim 15, wherein the first alignment protrusion further comprises a plurality of alignment surfaces, and wherein the plurality of receiving edges are adapted to receive the plurality of alignment surfaces.

16. The indexable valve of claim 1, wherein the valve body and the alignment collar are adapted to rotate together along a central axis when the first alignment protrusion is received by the first receiving portion.

17. An indexable valve comprising:
a valve assembly including:
a valve housing forming a fluid channel therein, the fluid channel having opposing first and second openings, the first opening including a set of internal threads;
a ball valve disposed in the fluid channel;
an actuation device handle adapted to actuate the ball valve;
a first alignment protrusion formed on an outer surface of the valve housing proximate to the first opening; and
a second alignment protrusion formed on the outer surface of the valve housing proximate to the first opening;
an alignment collar including:
a first receiving feature adapted to matingly receive the first alignment protrusion;
a second receiving feature formed on the alignment collar and adapted to matingly receive the second alignment protrusion; and
a flange including outwardly protruding bosses wherein a first portion of the outwardly protruding bosses have a first height and a second portion of the outwardly protruding bosses have a second height which is shorter than the first height;
a gasket including through holes; and
a fitting having a first end including a set of external threads and a second end, wherein the set of external threads is adapted to threadably engage the internal threads of the valve housing.

18. The indexable valve of claim 17, wherein the second end of the fitting includes a through-hull fitting.

19. The indexable valve of claim 17, wherein the first receiving portion further comprises one or more receiving edges.

20. The indexable valve of claim 17, wherein the gasket further comprises an inner seal.
